(19) United States
(12) Patent Application Publication
(10) Pub. No.: US 2009/0160188 A1
(43) Pub. Date: Jun. 25, 2009

(54) Migler's windmill as a lamppost-windmill, and with sails mounted on a common mast, and with horizontally yoked sails, and as a river-turbine, and as a windmill-sailboat

(76) Inventor: Bernard Migler, Cherry Hill, NJ (US)

Correspondence Address: Bernard Migler, 1405 Autumn Lane, Cherry Hill, NJ, 08003, US

(21) Appl. No.: 12/002,963

(22) Filed: Dec. 20, 2007

(51) Int. Cl. F03D 9/00

(52) U.S. Cl. 290/44

(57) ABSTRACT

The disclosure presents several embodiments of Migler's vertical axis windmill. In the first, the windmill is adapted as a windmill-lamppost which stores electrical energy during daylight and operates the lamps at night. In the second, some sail restraints are eliminated by mounting sails on a common mast. In the third, a yoke allows sails to be mounted close together on a horizontal arm and also eliminates some sail restraints. In the fourth, Migler's vertical axis windmill is submerged in a river, with additional generators used to harness the slow movement of the water. In the fifth, a boat is powered by Migler's vertical axis windmill using direct drive of the propeller. In the sixth, a boat is powered by Migler's vertical axis windmill using a transmission to enhance propeller speed. In the seventh a boat is powered by Migler's vertical axis windmill using electrical energy to operate an electric motor. In the eighth, a boat is powered by Migler's vertical axis windmill using a storage battery to operate an electric motor when there is no wind. In the ninth a boat is powered by Migler's vertical axis windmill, having pontoons to provide stability during strong crosswinds.

### FIELD OF THE INVENTION

The device relates generally to the field of windmills or wind turbines for the production of electricity. More specifically it relates to the field of vertical axis wind turbines.

### BACKGROUND OF THE INVENTION

### 1) Lampost-Windmill

Interstate highway lampposts expend considerable energy in lighting their bulbs at night. Means to reduce the cost of operating these lampposts would be useful. In an embodiment of Migler's vertical axis windmill (U.S. Pat. No. 6,926,491 B2 and USPTO publication number US-2007-0248450-A1; patent allowed but not yet issued) hereby incorporated by reference) as a lamppost-windmill, the tower of the lamppost becomes the tower of the windmill. The invention reduces the cost of operating these lampposts by harnessing and storing the energy of the wind during daylight and using that stored energy to light the bulbs at night.

### 2 and 3) Common Mast and Yoked Pairs of Sails

In Migler's vertical axis wind turbine, each sail requires two sail restraints. These sail restraints increase the cost and complexity of the device, and eliminating some of them would be useful. The invention eliminates some of these sail restraints by using a common mast in one embodiment and yoking pairs of adjacent sails in another embodiment.

### 4) River-Turbine

Flowing water in a river or estuary holds potential energy. A simple means of capturing some of that energy is possible using an embodiment of Migler's vertical axis windmill. The main problem in doing so is the fact that the water flows slowly, compared to the wind. This problem is solved by the use of secondary generators driven by each mast.

### 5) Windmill-Sailboat

Sailboats can sail in any direction except directly into the wind, and cannot sail when there is no wind. These two problems are solved in an embodiment of Migler's vertical axis windmill as a sailboat-windmill. The invention described here utilizes the fact the windmill rotates in a constant direction regardless of the direction of the wind striking the windmill. The energy that is captured is then used to propel the sailboat in any direction. Alternatively the energy can be stored in a battery and used when there is no wind.

### BRIEF SUMMARY OF THE INVENTION

In an embodiment of Migler's wind turbine, the tower is the tower of a lamppost of the type used on the Interstate Highway System and other major roads. Rotation of the tower collar drives a generator and the electrical energy produced by the generator is stored in a battery. At night, or when a solar cell on the device indicates low light, the energy stored in the battery is used to light the lamps.

In Migler's vertical axis wind turbine, sails may be mounted both above and below a horizontal arm, with sail restraints for every sail. In one of the inventions described here, the sail restraints for the lower (or upper) sail are eliminated by yoking the upper and lower sails to a common mast. The result is a reduction in cost and complexity.

In Migler's vertical axis wind turbine two or more sails can be mounted horizontally along a horizontal arm, with each sail having its own sail restraints. The sails must be kept a sufficient distance apart so as not to collide with each other. For example if the width of each sail is 10 feet, then the masts for the sails must be mounted at least 20 feet apart. If the masts could be mounted say 12 feet apart, then more sails could be mounted along a horizontal arm. In one of the inventions described here the masts are mounted closer together by means of a yoke between the masts. The yoke prevents collisions between the sails.

A recent attempt to install a horizontal axis (wind) turbine in the East River of NYC failed, with the destruction of the machine for unknown reasons. Since the East River is actually a tidal estuary, that is, the flow of water changes direction with the tide. This change creates a problem for a horizontal axis machine since the machine has to reverse the direction it is facing with each change in the direction of flow of the water. Migler's vertical axis wind turbine solves this problem. When it is submerged and adapted as a river-windmill, it does not need to be reversed with each change in direction of flow of the water. This is due to the fact that Migler's horizontal axis machine rotates in a constant direction, regardless of the direction of the wind, or in this case, the direction of flow of the water.

The problem with this adaptation of Migler's machine is that the flow of water is usually so slow that there is essentially no gybe that normally occurs with the higher speeds of wind. However, the force behind the slowly flowing water is much greater that the force of the wind at low wind speed. To harness the energy in this slowly flowing water, each sail drives its own secondary generator, while the rotation of the tower collar continues to drive its primary generator. The electrical energy generated by the machine is the result of the combination of all the generators.

Sailboats can sail in any direction except directly into the wind, and cannot sail when there is no wind. In the embodiment of Migler's vertical axis windmill described here the windmill is mounted on a boat. The energy of the wind is used to drive a generator which provides electrical energy for an electric motor which rotates a drive shaft that turns a propeller in the water A conventional rudder controls the direction of movement of the sailboat. Pontoons provide stability during crosswinds. Since the windmill rotates in a constant direction regardless of the direction of the wind the sailboat can sail in any direction. In addition, excess electrical energy is stored as electrical energy in a battery on the boat. The energy stored in the battery is then used to drive the electric motor when there is no wind. In another embodiment the rotary motion of the tower collar is translated directly into rotary motion of a horizontal shaft to which the propeller is secured.

### BRIEF DESCRIPTION OF THE DRAWINGS

FIG. 1 is a three dimensional view of an embodiment of Migler's vertical axis windmill as a lamppost-windmill. In this embodiment the tower of the lamppost serves as the tower of the windmill.

FIG. 2 is a three dimensional view of an embodiment of Migler's vertical axis windmill in which the sails above and below each horizontal arm are secured to a common mast, and the sail restraints for the lower (or upper) sails are eliminated.

FIG. 3 is a three dimensional view of an embodiment of Migler's vertical axis windmill in which three adjacent sails on a horizontal arm are linked by a yoke, eliminating the sail restraints for two of the sails and allowing the sails to be mounted close together.

FIG. 4 is a cross sectional view of an embodiment of Migler's vertical axis windmill which is adapted for use submerged in a river or estuary. In this view the water should be understood as flowing toward the reader. The sail on the right side of the figure is being driven slowly by the flow of the water toward the reader and the sail on the left side of the figure is “feathered” and is moving away from the reader, that is, upriver. In this embodiment the tower collar drives a primary generator, and the mast of each sail drives a secondary generator.

FIG. 5 is a three dimensional view of an embodiment of Migler's vertical axis windmill as a windmill-sailboat. The windmill-sailboat can sail directly into the wind.

FIG. 6 is a cross-sectional side view of the interior of the boat shown in FIG. 5 utilizing only windmill-generated mechanical energy to rotate the drive shaft and propeller of the boat.

FIG. 7 is a cross-sectional side view of the interior of the boat shown in FIG. 6 utilizing only windmill-generated mechanical energy to rotate the drive shaft and propeller of the boat through a transmission.

FIG. 8 is a cross-sectional side view of the interior of the boat shown in FIG. 7, utilizing windmill-generated electricity to rotate the drive shaft and propeller of the boat by an electric motor.

FIG. 9 is a cross-sectional side view of the interior of the boat shown in FIG. 8, having a storage battery and control means to run the electric motor when there is no wind.

FIG. 10 is a three-dimensional view of the windmill-sailboat shown in FIG. 5 with pontoons for lateral stability during crosswinds.

### DETAILED DESCRIPTION OF THE INVENTION

### 1) Lamppost-Windmill

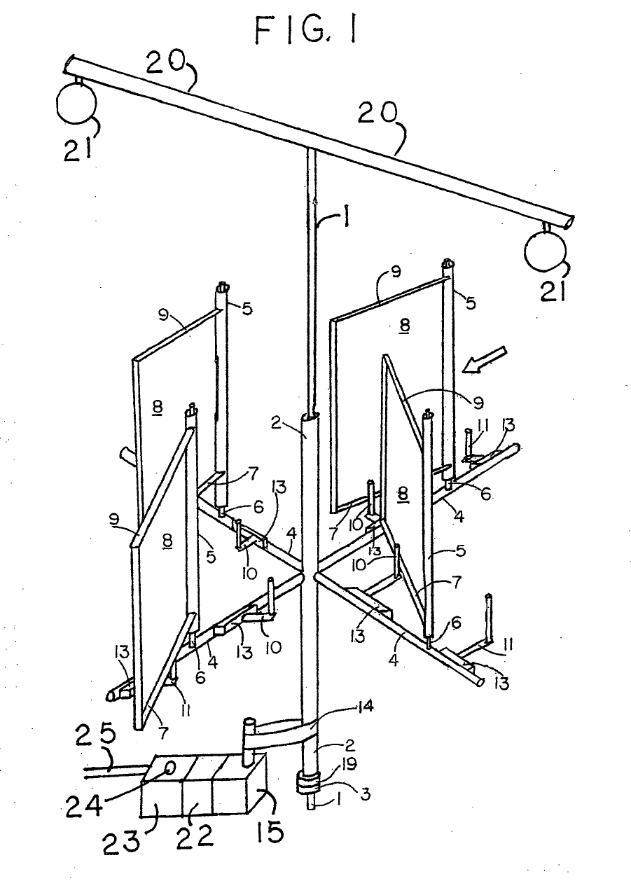

Referring now to the drawing in FIG. 1 there is shown a three dimensional drawing of Migler's vertical axis windmill adapted as a lamppost-windmill. The reader is referred to that patent for a detailed description of each part of the windmill and the operation of its adjustable sail restraints and motorized sail restraint controllers.

The arrow in FIG. 1 indicates the direction of the wind. The lamppost-tower 1 has support arms 20 that are secured to the tower 1. Lamps 21 that can illuminate a roadway are connected to the support arms 20. The tower 1 has a rotatable tower collar 2. Horizontal arms 4 are secured to the rotatable tower collar 2. Sail restraints 10 and 11 and motorized sail restraint controllers 13 are secured to each horizontal arm 4. Masts 6 are secured to the horizontal arms 4 between sails restraints 10 and 11. Each mast 6 has a rotatable mast collar 5. Booms 7, sail frames 5 and sails 8 are secured to each mast collar 5. The tower collar 2 rests on a thrust bearing 19, which rests on a shaft collar 3 secured to the tower 1. Rotation of the tower collar 2 turns a belt 14 which drives a generator 15. In another embodiment the generator is driven by a chain rather than a belt. In another embodiment the generator is driven by a gear secured to the tower, rather than a belt. Electrical energy produced by the generator 15 is stored in a battery 22. A solar cell 24 and a control box 23 housing conventional control circuitry, including a clock (not shown) control the lighting of the lamps 21. An electrical cable (not shown) connects the control box 23 to the lamps 21 through the tower 2. A cable carrying conventional electrical power 25 is connected to the control box 23. At night, or when the solar cell 24 detects low light, the energy stored in the battery 22 is directed by the control box 23 to light the lamps 21. If the energy stored in the battery is not sufficient to light the lamps, then the control box 23 directs power from the conventional electrical power cable 25 to the lamps 21.

### 2) Common Mast

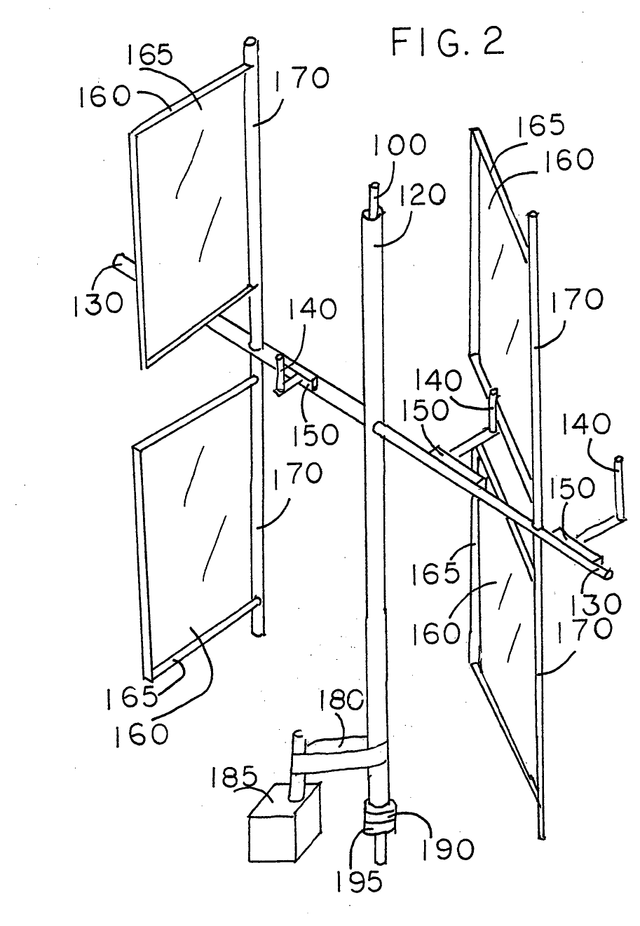

Referring now to the drawing in FIG. 2 there is shown a three dimensional drawing of Migler's vertical axis windmill with a tower 100, tower collar 120 and horizontal arms 130. The tower 100 is secured to the ground or other stable surface. The tower collar 120 rests on a thrust bearing 190, which rests on a shaft collar 195 secured to the tower 100. A sail frame 165 and a sail 160 is secured to a rotatable mast 170 on each horizontal arm 130. The sails 160 and sail frames 165 are restrained by adjustable sail restraints 140 and motorized sail restraint controllers 150. The sail restraints 140 and motorized sail restraint controllers 150 restrain only one of the two sails 160 on the common mast 170. The wind should be understood as coming from the direction shown by the arrow, and is driving the sails 160 on the right side of the figure toward the reader. The sails 160 on the left side of the figure are feathered and moving upwind, that is, away from the reader. With sails mounted on a common mast 170, the device operates as it would with sail restraints 140 and motorized sail restraint controllers 150 for every sail 160. The result of mounting two sails on a common mast is a saving in cost of construction and a reduction in complexity. A belt 180 driven by the tower collar 120 causes the rotation of a gearbox and generator 185 to produce electricity. In another embodiment the generator is driven by a chain rather than a belt. In another embodiment the generator is driven by a gear secured to the tower, rather than a belt. In another embodiment more than two sails are used. with sail restraints 140 and motorized sail restraint controllers 150 for every sail 160. The result of mounting two sails on a common mast is a saving in cost of construction and a reduction in complexity. A belt 180 driven by the tower collar 120 causes the rotation of a gearbox and generator 185 to produce electricity. In another embodiment the generator is driven by a chain rather than a belt. In another embodiment the generator is driven by a gear secured to the tower, rather than a belt. In another embodiment more than two sails are used. In another embodiment Migler's automatic sail restraints replace the sail restraints shown in FIG. 2.

### 3) Yoked Sails

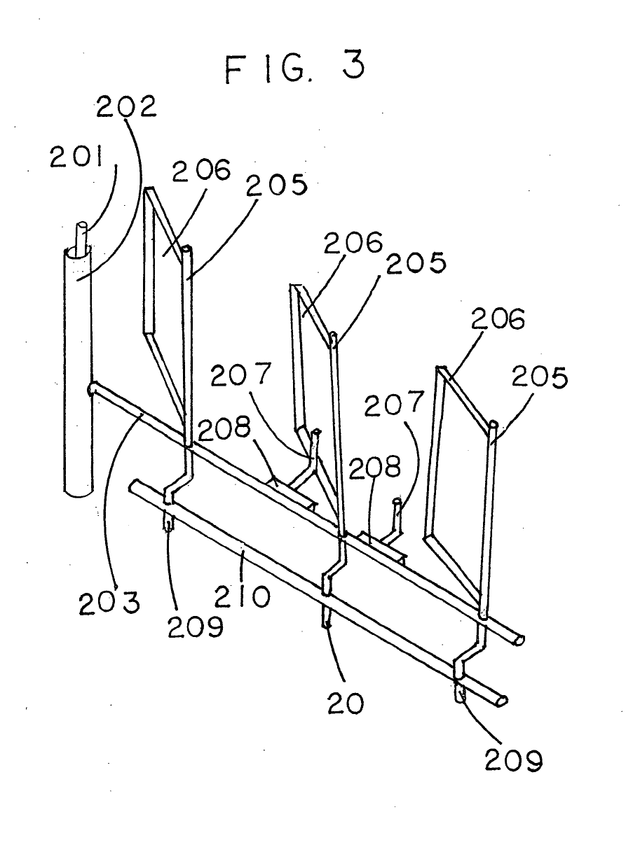

Referring now to the drawing in FIG. 3 there is shown a three dimensional drawing of a fragment of Migler's vertical axis windmill. The drawing shows only a part of the tower 201, and tower collar 202, and only one of a plurality of horizontal arms 203. The tower 201 is secured to the ground or other stable surface (not shown.) The tower collar 202 rests on a thrust bearing (not shown), which rests on a shaft collar (not shown) secured to the tower 201. Three rotatable masts 205 are secured to the horizontal arm 203. A sail frame and sail 206 is secured to each rotatable mast 205. A yoke arm 209 is secured at one end of each mast 205. The yoke arms 209 are connected to each other by a yoke 210. One of the masts 205 and its sails 206 is controlled by sail restraints, 207 and motorized sail restraint controllers 208, but other masts are not. The yoke 210 causes the sails 206 to move simultaneously and in the same direction, negating the need for additional sail restraints 207 and sail restraint controllers 208.

One result of connecting sails 206 by a yoke 210 is a saving in cost of construction and a reduction in complexity. More importantly, by yoking the masts 205 and sails 206 they can be mounted close together on a horizontal arm 203, the distance between the sails being only slightly more that the width of the widest sail. Without the yoke 210 two sails would have to be mounted at a much greater distance, the width of two sails, in order to avoid collisions between the sails.

A belt (not shown) driven by the tower collar 202 causes the rotation of a gearbox and generator (not shown) to produce electricity. In another embodiment the gearbox and generator are driven by a chain rather than a belt. In another embodiment the gearbox and generator is driven by a gear secured to the tower, rather than a belt.

### 4) River-Turbine

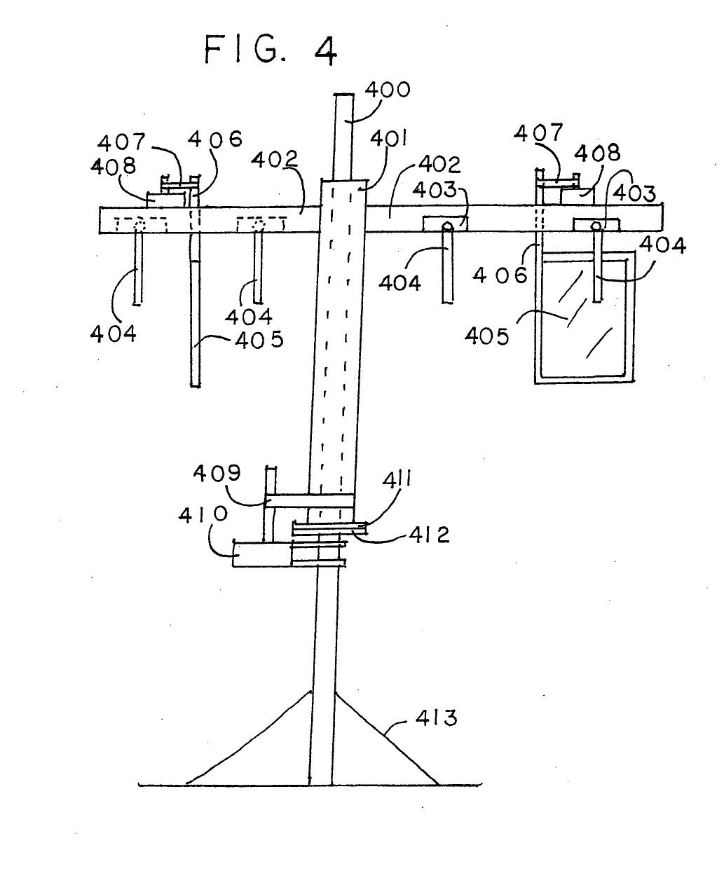

Referring now to the drawing in FIG. 4 there is shown a cross-sectional side view of Migler's vertical axis windmill, submerged in water, and adapted as a river-windmill, having a tower 400, a tower collar 401 and horizontal arms 402 secured to the tower collar. The tower 400 is secured to the ground. Guy wires 413 help to support the tower 400. The tower collar 401 rests on a thrust bearing 411, which rests on a shaft collar 412 secured to the tower 400. A rotatable mast 406 is secured to each horizontal arm 402. A sail frame and sail 405 is secured to each rotatable mast 406 on each horizontal arm 402. Adjustable sail restraints 404 are controlled by motorized sail restraint controllers 403. A main belt 409 is driven by the tower collar 401 and drives a main generator 410. In another embodiment the main generator 410 is driven by a main chain rather than a belt. In another embodiment the main generator 410 is driven by a main gear secured to the tower, rather than a belt.

Each rotatable mast 406 drives a secondary belt 407 which drives a secondary generator 408. In another embodiment the secondary generator 408 is driven by a secondary chain rather than a belt. In another embodiment the secondary generator 408 is driven by a secondary gear secured to the tower, rather than a belt.

The electrical output of the device is the sum of the power generated by the main generator 410 and the secondary generators 408. The slow movement of the water, compared to wind, results in the absence of a rapid gybe. As a result the energy of a rapid gybe that is captured in Migler's vertical axis windmill is not available in slowly flowing water. However, since the force of the water on the sails 405 is greater in water than in air, due to the mass of the water, some of that energy is captured by the secondary generators 408 when the sails slowly rotate from one sail restraint 404 to another sail restraint 404 during each cycle.

The flow of water should be understood as coming toward the reader and is driving the sail 405 on the right side of the figure toward the reader. The sail 405 on the left side of the Figure is shown on edge and feathered and should be understood as moving upriver and away from the reader.

In another embodiment three or more horizontal arms are used. The device may also be used on land.

### 5) Windmill-Sailboat

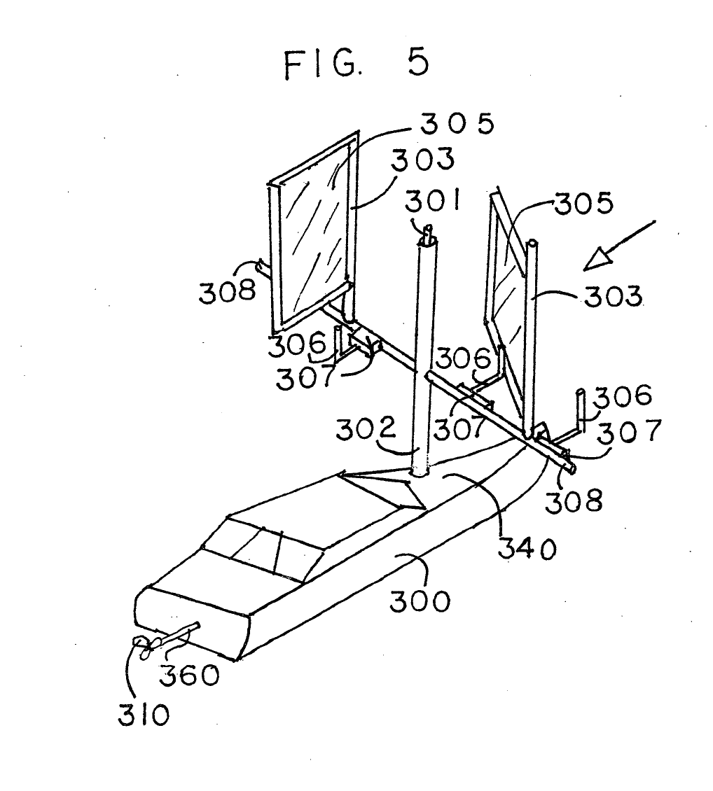

Referring now to the drawing in FIG. 5, there is shown a three dimensional view of Migler's vertical axis windmill adapted as a windmill-sailboat 300. The windmill-sailboat 300 has a tower 301, a rotatable tower collar 302 which penetrates the deck 340 of the boat, and horizontal arms 308 secured to the tower collar 302. A sail frame and sail 305 is secured to a rotatable mast 303 on each horizontal arm 308. The sails 305 are restrained by sail restraints 306 and motorized sail restraint controllers 307. The windmill-sailboat 300 has a rudder (not seen in this figure) and a keel 380. The arrow indicates that the wind is coming directly toward the boat; the boat 300 should be understood to be moving directly into the wind. The horizontal arms 308 on the tower collar 302 of the boat 300 should be understood as rotating clockwise, with the sail on the right side of the figure moving toward the reader, and the sail on the left side of the figure moving away from the reader. A propeller 310 is turned by a drive shaft 360. In another embodiment, the sails 305 may be partially or completely reefed, as disclosed in Migler's vertical axis windmill.

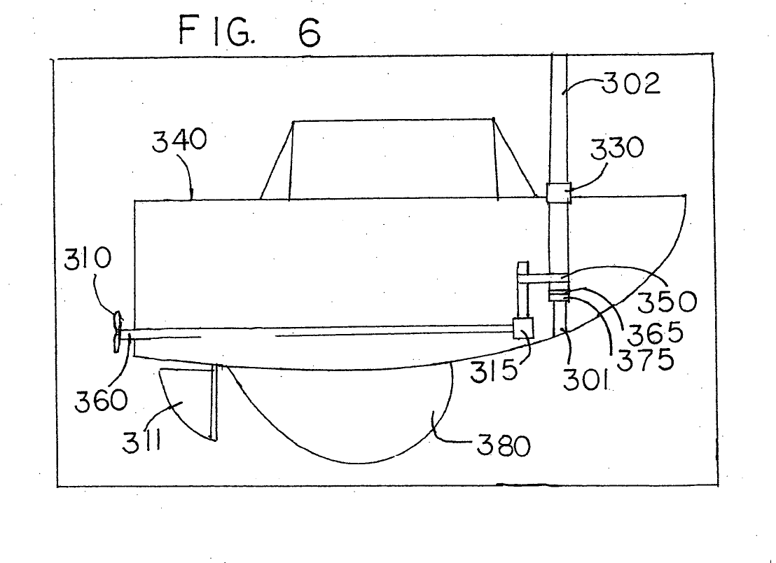

Referring now to the drawing in FIG. 6 there is shown a cross-sectional side view of the interior of the windmill-sailboat shown in FIG. 5, showing only the lower end of the tower collar 302 below the horizontal arms 308 (not shown.) The tower 301 is secured to a stable point in the boat. The tower collar 302 passes through a radial bearing 330 in the deck 340. The tower collar 302 rests on a thrust bearing 365, which rests on a shaft collar 375 secured to the tower 301. The tower collar 302 turns a belt 350 which drives a right-angle gearbox 315. In another embodiment the right-angle gearbox 315 is driven by a chain rather than a belt. In another embodiment the right-angle gearbox 315 is driven by a gear secured to the tower, rather than a belt.

The right angle gearbox 315 turns a drive shaft 360. A propeller 310 is secured to the end of the drive shaft 360. Rotation of the propeller 310 propels the boat in the water. The pilot (not shown) operates a conventional rudder 311 to control the direction of sail. A keel 380 provides stability against cross winds.

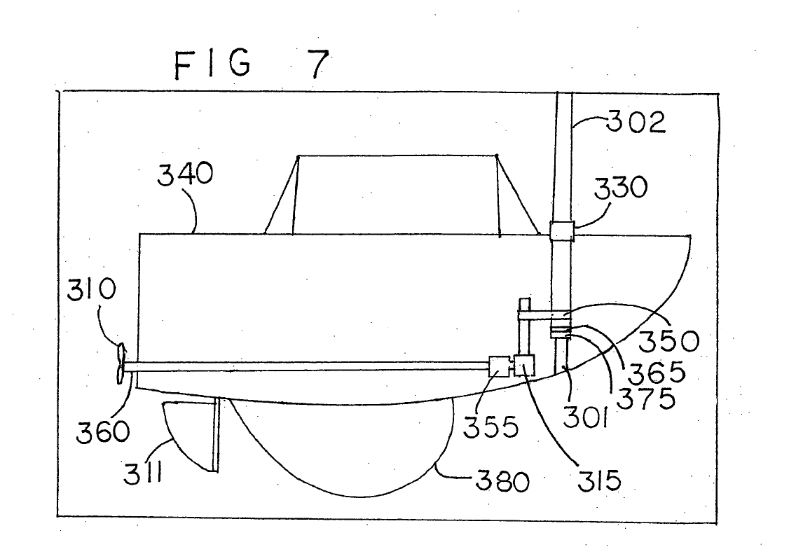

Referring now to the drawing in FIG. 7 there is shown a cross-sectional side view of the interior of the windmill-sailboat shown in FIG. 5, showing only the lower end of the tower collar 302 below the horizontal arms 308 (not shown.) The tower 301 is secured to a stable point in the boat. The tower collar 302 passes through a radial bearing 330 in the deck 340. The tower collar 302 rests on a thrust bearing 365, which rests on a shaft collar 375 secured to the tower 301. The tower collar 302 turns a belt 350 which drives a right angle gearbox 315. In another embodiment the right-angle gearbox 315 is driven by a chain rather than a belt. In another embodiment the right-angle gearbox 315 is driven by a gear secured to the tower, rather than a belt. The right angle gearbox 315 turns a transmission 355. The transmission produces accelerated rotation of a horizontal drive shaft 360. The pilot (not shown) controls the gears (not shown) of the transmission 355. A propeller 310 is secured to the end of the drive shaft 360. Rotation of the propeller 310 propels the boat in the water. The pilot (not shown) operates a conventional rudder 311 to control the direction of sail. A keel 380 provides stability against cross winds.

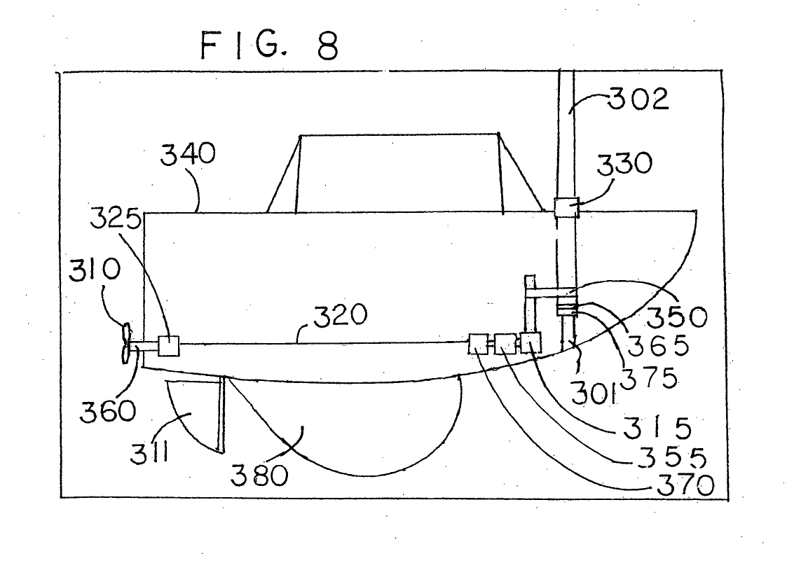

Referring now to the drawing in FIG. 8 there is shown a cross-sectional side view of the interior of the windmill-sailboat shown in FIG. 5, showing only the lower end of the tower collar 302 below the horizontal arms 308 (not shown.) The tower 301 is secured to a stable point in the boat. The tower collar 302 passes through a radial bearing 330 in the deck 340. The tower collar 302 rests on a thrust bearing 365, which rests on a shaft collar 375 secured to the tower 301. The tower collar 302 turns a belt 350 which turns a right-angle gearbox 315. In another embodiment the right-angle gearbox 315 is driven by a chain rather than a belt. In another embodiment the right-angle gearbox 315 is driven by a gear secured to the tower, rather than a belt.

The right angle gearbox 315 turns a transmission 355. The output of the transmission 355 serves as input to a generator 370 which provides electricity to an electric motor 325 through a cable 320. The electric motor 325 turns a drive shaft 360, which turns a propeller 310 in the water. The pilot (not shown) operates the rudder 311 to control the direction of sail. A keel 380 provides stability against cross winds.

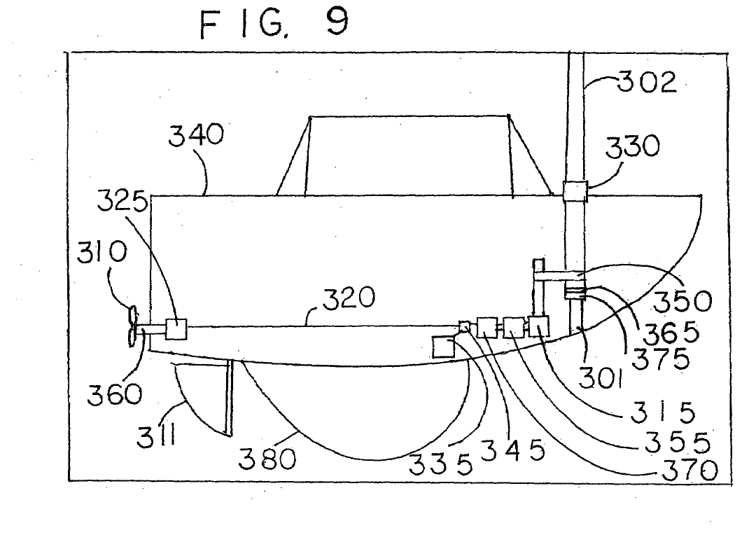

Referring now to the drawing in FIG. 9 there is shown a cross-sectional side view of the interior of the windmill-sailboat shown in FIG. 5, showing only the lower end of the tower collar 302 below the horizontal arms 308 (not shown.) The tower 301 is secured to a stable point in the boat. The tower collar 302 passes through a radial bearing 330 in the deck 340. The tower collar 302 rests on a thrust bearing 365, which rests on a shaft collar 375 secured to the tower 301. The tower collar 302 turns a belt 350 which turns a right angle gearbox 315. In another embodiment the right-angle gearbox 315 is driven by a chain rather than a belt. In another embodiment the right-angle gearbox 315 is driven by a gear secured to the tower, rather than a belt.

The right angle gearbox 315 turns a transmission 355. The output of the transmission 355 serves as input to a generator 370. The pilot (not shown) using a conventional switch 345 directs some or all of the electrical power produced by the generator 370 to an electric motor 325 through a cable 320 or to a battery 335. When there is insufficient wind the pilot directs electrical energy from the battery 335 to the electric motor 325. The electric motor 325 turns a drive shaft 360, which turns a propeller 310 in the water. The pilot (not shown) operates the rudder 311 to control the direction of sail. A keel 380 provides stability against cross winds. The pilot (not shown) also controls the gears and rotational speed of the transmission 355.

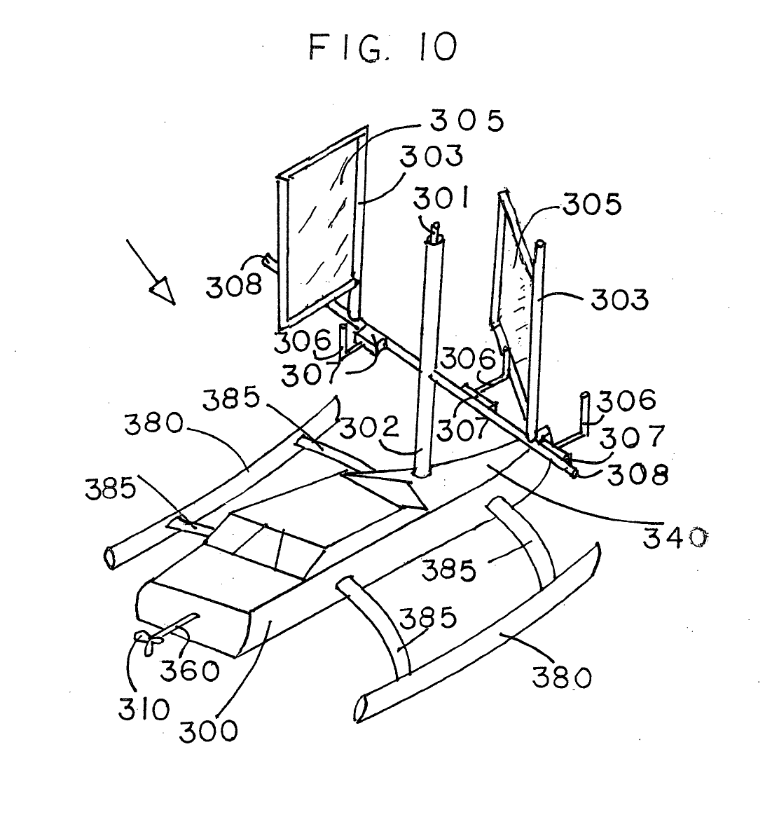

Referring now to the drawing in FIG. 10, there is shown another embodiment of the device shown in FIG. 5. In this embodiment additional stability against crosswinds is provided by pontoons 380. The pontoons are secured to the boat by pontoon supports 385. The arrow in the figure indicates that the wind should be understood as coming from left to right over the side of the boat, that is, as a crosswind. Stability against crosswinds is provided by the keel (not seen in this figure) and by the pontoons 380. Stability against crosswinds may also be achieved by partially reefing the sails as described in Migler's vertical axis windmill. Partially reefing the sails reduces the sail area, which reduces lateral force on the boat, which enhances lateral stability during strong crosswinds.

I claim:

1) Migler's vertical axis windmill adapted as a lamppost-windmill, comprising;
a). a tower,
b). a rotatable tower collar secured to the tower,
c). a plurality of horizontal arms secured to the rotatable tower collar,
d). a mast secured to each horizontal arm,
e). a rotatable mast collar secured to each mast,
f). a sail and a sail frame secured to each rotatable mast collar,
g). an adjustable sail restraint and sail restraint controller on one side of each rotatable mast, and an adjustable sail restraint and sail restraint controller on the other side of each rotatable mast,
h). belt, chain or gear means to drive a gearbox-generator,
i). a gearbox-generator,
j). a storage battery,
k). a photocell,
l). a clock
m). one or more lamps
n). one or more lamp-arms,
o). a cable with external electrical power,
p). a control module, having connections to the clock, the photocell, the storage battery, the generator, the external electrical power, and the lamps;
whereby, during daytime hours, when daylight is at normal levels, the control module stores energy from the generator in the storage battery; during daytime hours, if daylight is sufficiently below normal levels requiring illumination of the lamps, the control module directs power from the storage battery or from the generator to the lamps; during evening as determined by the clock, the control module directs power from the storage battery or from the generator to the lamps; at any time that the storage battery or generator is unable to provide sufficient power to the lamps, the control module directs external electrical power to the lamps.

2) Migler's vertical axis windmill having sails connected by a common mast, comprising:
a). a tower,
b). a rotatable tower collar on the tower,
c). a plurality of horizontal arms secured to the rotatable tower collar,
d). a rotatable common mast secured to each said horizontal arm, having an extension above and below said horizontal arm,
e). a sail and a sail frame secured to said upper and lower extensions of said rotatable common mast,
f). adjustable sail restraints and sail restraint controllers on both sides of only one extension of said rotatable common mast,
g). belt, chain or gear means to drive a gearbox-generator,
h). a gearbox-generator,
whereby, by virtue of the common mast, if wind causes the sail on the upper extension of the rotatable common mast to begin to move or gybe first, the sail on the lower mast will move or gybe simultaneously, and if the wind causes the sail on the lower extension of the rotatable common mast to begin to move or gybe first, the sail on the upper mast moves or gybes simultaneously; and if the sail on the upper mast becomes feathered by the retraction of the inner or outer adjustable sail restraints, or by excessive wind the sail on the lower mast becomes feathered also.

3) Migler's vertical axis windmill with adjacent sails connected by a yoke, comprising:
a). tower,
b). a rotatable tower collar on the tower,
c). a plurality of horizontal arms secured to the rotatable tower collar,
d). a plurality of rotatable masts secured to each of the horizontal arms,
e). a sail and a sail frame secured to each rotatable mast,
f). an adjustable sail restraint and motorized sail restraint controller for one of the rotatable masts,
g). a yoke arm secured to one end of each rotatable mast,
h). a yoke secured between the yoke arms,
i). belt, chain or gear means to drive a gearbox-generator,
j). a gearbox and generator;
whereby, if wind causes one sail to begin to move or gybe first, the yoke causes the other sails to gybe also, and if the one sail becomes feathered by the retraction of the sail restraints, the yoke causes the other sails to become feathered also.

4) Migler's vertical axis windmill adapted as a river-windmill comprising;
a). a tower secured to a river bottom,
b). a rotatable tower collar on the tower,
c). a plurality of horizontal arms secured to the rotatable tower collar,
d). a rotatable mast secured to each horizontal arm,
e). a sail secured to each rotatable mast,
f). an adjustable sail restraint and sail restraint controller on one side of the rotatable mast, and an adjustable sail restraint and sail restraint controller on the other side of the mast,
g). a main belt, chain or gear secured to the tower collar,
h) a main gearbox and a main generator driven by said main belt, chain or gear,
i) a secondary belt, chain or gear secured to said rotatable mast,
j). a secondary gearbox and secondary generator driven by said secondary belt, chain or gear,
whereby, when flowing water causes the rotation of the sails and horizontal arms, electric energy is produced by the rotation of the tower collar and its belt-driven generator, and electric energy is also produced by the rotation of the rotatable mast and its belt-driven secondary generator.

5) Migler's vertical axis windmill adapted as a windmill-sailboat, comprising;
a). a boat, having a keel and a rudder,
b). a tower secured to said boat,
c). a rotatable tower collar on the tower,
d). a plurality of horizontal arms secured to the rotatable tower collar,
e). a rotatable mast secured to each of the horizontal arms,
f). a sail and a sail frame secured to each rotatable mast,
g). an inner adjustable sail restraint and sail restraint controller on one side of each mast, and an outer adjustable sail restraint and sail restraint controller on the other side of each mast on each horizontal arm,
h). belt, chain or gear means to drive a right-angle gearbox,
i). a right angle-gearbox,
j). a drive shaft driven by said right-angle gearbox,
k). a propeller secured to said drive shaft,
whereby, when wind causes the rotation of the sails, horizontal arms, and tower collar, the right angle gearbox rotates the drive shaft horizontally, rotating the propeller in the water, thereby propelling the boat. The boat can sail directly into the wind or into any other heading.

6) The device of claim 5, having a transmission, comprising,
a). a boat having a keel and a rudder,
b). a tower secured to said boat,
c). a rotatable tower collar on the tower,
d). a plurality of horizontal arms secured to the rotatable tower collar,
e). a rotatable mast secured to each of the horizontal arms,
f). a sail and a sail frame secured to each mast,
g). an inner adjustable sail restraint and sail restraint controller on one side of each mast, and an outer adjustable sail restraint and sail restraint controller on the other side of each mast,
h). belt, chain or gear means to drive a right-angle gearbox,
i). a right angle-gearbox,
j) a transmission, capable of increased rotational speed, driven by said right-angle gearbox,
k). a drive shaft, driven by said transmission,
l). a propeller secured to said drive shaft,
whereby, when wind causes the rotation of the sails, horizontal arms, and tower collar, the right angle gearbox rotates the transmission, which turns the drive shaft horizontally at an increased speed, rotating the propeller in the water, thereby propelling the boat. The boat can sail directly into the wind or into any other heading.

7) The device of claim 5 with a transmission, electricity generator and electrical motor comprising;
a). a boat, having a keel and a rudder,
b). a tower secured to said boat,
c). a rotatable tower collar on said tower,
d). a plurality of horizontal arms secured to the rotatable tower collar,
e). a rotatable mast secured to each of the horizontal arms,
f). a sail and a sail frame secured to each mast,
g). an inner adjustable sail restraint and sail restraint controller on one side of each mast, and an outer adjustable sail restraint and sail restraint controller on the other side of each mast on each horizontal arm,
h). belt, chain or gear means to drive a right-angle gearbox,
i). a right angle gearbox,
j) a transmission, capable of increased rotational speed, driven by said right-angle gearbox,
k) an electricity generator,
l) an electric motor, with input from said electricity generator,
m). a drive shaft and propeller driven by said electric motor,
whereby, when wind causes the rotation of the sails, horizontal arms, and tower collar, the right-angle gearbox is turned, the transmission rotates at increased speed, the electric generator produces electricity for the electric motor which turns the driveshaft and propeller to propel the boat in the water. The boat can sail directly into the wind or into any other heading.

8) The device of claim 5 with a transmission, electricity generator, electrical motor, storage battery and control module, comprising;
a). a boat, having a keel and a rudder,
a.) a tower secured to the deck of said boat,
b). a rotatable tower collar on the tower,
c). a plurality of horizontal arms secured to the rotatable tower collar,
d). a rotatable mast secured to each of the horizontal arms,
e). a sail and a sail frame secured to each mast,
f). an inner adjustable sail restraint on one side of each mast, and an outer adjustable sail restraint on the other side of each mast on each horizontal arm,
j). belt, chain or gear means to drive a right-angle gearbox,
k). a right-angle gearbox,
l) a transmission, capable of increased rotational speed, driven by said right-angle gearbox,
k) an electricity generator driven by said transmission,
l) an electric motor driven by said electricity generator,
m) a drive shaft and propeller driven by said electric motor,
n). a storage battery,
o). a control module,
whereby, when wind causes the rotation of the sails, horizontal arms, and tower collar, the right-angle gearbox is turned, the transmission rotates at increased speed, the generator is operated, and electric energy is directed to the control module where the operator of the boat then directs the electric energy exclusively to the electric motor to propel the boat, or exclusively to the storage battery for later use, or divides the energy between the storage battery and the electric motor. The boat can sail directly into the wind or into any other heading.

9) The device of claim 5 with pontoons, comprising;
a). a boat, having a keel and a rudder,
a.) a tower secured to said boat,
b). a rotatable tower collar on said tower,
c). a plurality of horizontal arms secured to the rotatable tower collar,
d). a rotatable mast secured to each of the horizontal arms,
e). a sail and a sail frame secured to each rotatable mast,
f). an inner adjustable sail restraint and sail restraint controller on one side of each mast, and an outer adjustable sail restraint and sail restraint controller on the other side of each mast on each horizontal arm,
j). belt, chain or gear means to drive a right-angle gearbox,
k). a right angle-gearbox,
l). a drive shaft driven by said right-angle gearbox,
m). a propeller secured to said drive shaft,
n). pontoons and pontoon support arms;
whereby, when wind causes the rotation of the sails, horizontal arms, and tower collar, the right angle gearbox rotates the drive shaft horizontally, rotating the propeller in the water, thereby propelling the boat, and when wind blows across the boat, the pontoons provide increased horizontal stability. The boat can sail directly into the wind or into any other heading.
